(19) United States
(12) Patent Application Publication
(10) Pub. No.: US 2007/0274769 A1
(43) Pub. Date: Nov. 29, 2007

(54) Binder For Document

(76) Inventors: Hiroshi Shimada, Tokyo (JP); Daichi Kumai, Tokyo (JP); Kouichi Tanimoto, Tokyo (JP)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 10/599,641

(22) PCT Filed: Apr. 5, 2004
(86) PCT No.: PCT/JP04/04912

§ 371 Date: Oct. 4, 2006

(51) Int. Cl. B42F 13/20

(52) U.S. Cl. 402/31

(57) ABSTRACT

A binder for a document, comprising a base part, rings fitted to the base part and allowed to change in a closed ring attitude for biding the document and an open ring attitude for opening parts of the closed rings to pass the document therethrough before winding, and a switching mechanism fitted to the base part and switching between the closed ring attitude and the open ring attitude. The switching mechanism further comprises a switching lever swingably fitted to the base part. When the rings are in the open ring attitude, the switch mechanism is set so that the switching lever is allowed to pass through the open portion of the ring. Thus, the binder for the document with easiness of handling and excellent workability can be provided by improving so that only the advantages of a conventional ring type binder and a lever arch type binder can be utilized.

### TECHNICAL FIELD

The present invention relates to a technology concerning a binder in which a ring composed of ring members that can be opened/closed is opened/closed by an operation of a switching lever to bind a document or the like.

### BACKGROUND ART

On the inner side of the cover member of a sheet folder or the like is fixedly attached a binder having a plurality of ring members. As such a binder, what is called a ring type binder without a leverage that is opened forcibly using hands and a lever arch type binder in which rings are opened by a lever operation have been widely known conventionally.

A ring type binder has, for example, a strip-like base portion made of a metal plate and two rings provided thereon composed of a plurality of ring members. The ring members on one side among the ring members constituting the two rings are adapted to be swingable relative to the base portion. Thus, it is possible to change the position of the rings between a closed ring position for binding sheets of a document or the like and an open ring position in which a part of the closed rings is opened.

A lever arch type binder is disclosed, for example, in Patent Document 1. The binder disclosed in this document has a strip-like base portion made of a metal plate, two rings provided thereon composed of a plurality of ring members and an open/close mechanism having an operation lever for changing the position of the rings between a closed ring position and an open ring position. The ring members on one side among the ring members that constitute the two rings are adapted to be swingable relative to the base portion, and it is possible to open/close the rings by pressing down the operation lever.

Patent Document 1

Japanese Utility Model Application Laid-Open No. 57-24077

Among the above described conventional binders, the ring type binder is advantageous in that its structure is simple and it can be manufactured at low cost. The lever arch type binder is advantageous in that it is easy to use since the rings can be opened/closed by lever operation.

However, these conventional binders have the following problems to be solved.

(1) The ring type binder is not easy to operate (or use) since to open the rings, it is needed to forcibly open the ring members themselves by hands. In addition, it is not easy to use in that it is necessary to take care to prevent a finger(s) from being pinched between the ends of the ring members when closing the rings.

(2) The lever arch type binder has a large open/close mechanism that is arranged in the central portion between the two rings, and in the open state, the lever extends therefrom to the neighborhood of a ring. It not only obstructs filing and removal of a document or the like but also prevents a large amount of document sheets from being filed or removed at one time.

(3) In the structure like one disclosed in Patent Document 1 in which the ring members on one side are swingable relative to the base member, the degree of opening of the rings is small, and the opened portion is eccentric to one side. Therefore, workability in filing and removing a document or the like is low.

### DISCLOSURE OF THE INVENTION

In view of the above, an object of the present invention is to provide a binder for a document or the like with easiness of handling and good workability by figuring out a good way to utilizing only the advantages of the conventional ring type binder and lever arch type binder.

To achieve the object, the present invention adopts the following means.

A binder for a document or the like according to the present invention comprises:

a base portion;

a ring provided on the base portion that can change in its position between a closed ring position for binding a document or the like and an open ring position in which the closed ring is partly opened to allow filing of a document or the like; and

a switching mechanism provided on said base portion for switching between the closed ring position and the open ring position,

wherein the switching mechanism includes a switching lever swingably attached to said base portion and is adapted in such a way that when the ring is in the open ring position, the switching lever can pass through an open portion of the ring.

According to the present invention, the switching lever is adapted to be able to pass through an open portion of the ring when the ring is in the open ring position. By this feature, even while the ring is in the open ring position, it is possible to keep the free end of the switching lever in a retracted state by causing it to pass thorough the ring outwardly. Thus, the switching lever is prevented from coming to an obstructive position even during operations of inserting or removing a document or the like, and therefore replacement of the document or the like in both the left and right ring members is made possible. Accordingly, workability can be greatly enhanced.

It is preferred that said ring comprise a plurality of rings arranged along an longitudinal direction of the base portion with a spacing therebetween, and the switching mechanism be adapted in such a way that when each of the rings is in the open ring position, the switching lever can pass through the open portion of the rings. Even in the case where a plurality of rings are arranged along an longitudinal direction of the base portion with a spacing therebetween, by adapting the switching lever to be able to pass the open portion of each ring, it is possible to retract the free end of the switching lever outside the ring to prevent the switching lever from obstructing operations.

It is preferred that said ring have a first ring member and a second ring member, wherein the closed ring position is achieved when their ends are in contact with each other and the open ring position is achieved when their ends are spaced apart from each other and that the switching mechanism be constructed in such a way as to be able to operate in directions for causing the ends of the respective ring members to move toward and away from each other. With this structure, it is possible to make the degree of opening of the ring defined as the maximum distance between the ends large. This also can enhance workability.

It is preferred that the open portion of the ring that is formed when the respective ends of said ring members are spaced apart from each other be situated above the base portion and in the central region of the base portion with respect to the shorter length direction of the base portion. With this feature, a structure in which opening/closing timing of the ring relative to swinging of the switching lever from one swing position to the other swing position can be easily set.

It is preferred that said switching lever have a base end portion hinged to said base portion and a free end to be handled, and the base end portion be provided with a cam portion for adjusting the degree of opening of each of the rings in accordance with the swing position of the free end. With this feature, it is possible to open/close the rings only by operating the switching lever. Thus, a structure with a ease of use and good operationality can be achieved.

It is preferred that said base portion have a base body made of a metal plate, a cover portion that rises from the base body in such a way as to cover a central portion of the base body and a bearing portion provided on the cover portion, said bearing portion be arranged in a central region between the adjacent rings and constitute a part of a hinge of the switching lever. With this feature, it is possible to produce the base body, the cover portion and the bearing portion by processing a single metal plate, thereby reducing the number of parts and making the overall structure simple. In addition, it is possible to achieve covering by the cover portion, whereby advantages such as improvement in appearance and improvement in safety can also be expected.

Said switching mechanism may have two support members arranged side by side on said base member, each of the support members can be inclined in a sideways direction perpendicular to the longitudinal direction of the base portion, wherein the first ring member may be supported on one of the support members, the second ring member may be supported on the other of the support members, and between at least one of said support members and the base portion may be provided an elastic member that biases the support member in such a direction as to cause the ends of the ring members to move away from each other. With this feature, it is possible to operates the two support members simultaneously thereby changing the position of the ring between the closed ring position and the open ring position only by operating the switching lever. This can realize advantageous effects similar to those of the ring type binder.

It is preferred that said support members be constructed in the form of strip-like members made of metal plates having respective one side edge portions and the other side edge portions, one side edge portion of each of the support members be hinged to said base portion, the other side edge portions of the support members partly overlap each other on the base portion, and said elastic member be provided at least between one of the support members and the base portion. In this structure, it is sufficient to provide the elastic member for only one of the support members, which contributes to simplification of the structure.

Said ring may comprise two rings arranged along an longitudinal direction of said base portion with a spacing therebetween. Among first ring members and second ring members that constitute each of the two rings, each of the first ring member pair and the second ring member pair may be formed by bending a single metal wire. A connecting portion between the first ring members and a connecting portion between the second ring members may respectively have press portions arranged close to and parallel to each other in the central region of the base body and support portions serving as pivots of the first ring members and the second ring members. Each support portion may be supported in a rotatable manner relative to said base body, and said press portion may be adapted to be pressed by a cam portion of said switching lever. With this feature, it is possible to reduce the number of parts, reduce the manufacturing cost, and in addition enhance the rigidity of the ring members.

Said base portion may have a base body made of a metal plate and a bearing portion provided on a central portion of the base body, said bearing member may have a bottom plate and two standing tabs opposed to each other that rise from the bottom plate, the base end portion of said switching lever may be hinged to both the standing tabs, and said press portion may be disposed between said standing tabs. With this feature, it is possible to make the entire base portion including the switching mechanism compact.

It is preferred that an abutment plate that is movable along the press portion be provided between said press portion and said cam portion, and teeth engaging each other be provided on a surface of the abutment plate and a circumferential surface of said cam portion. With this feature, it is possible to ensure movement of the abutment plate and to transmit a force from the cam portion to the press portion reliably.

According to the present invention, by figuring out a good way to utilizing only the advantages of the conventional ring type binder and lever arch type binder, there is provided a binder for a document or the like with easiness of handling and good workability.

### BRIEF DESCRIPTION OF THE DRAWINGS

FIG. 1 is an overall perspective view of a binder according to a first embodiment of the present invention.

FIG. 2 includes a front view (a) and a side view (b) illustrating an operation of the binder according to the first embodiment of the present invention.

FIG. 3 includes a front view (a) and a side view (b) illustrating an operation of the binder according to the first embodiment of the present invention.

FIG. 4 includes a front view (a) and a side view (b) illustrating an operation of the binder according to the first embodiment of the present invention.

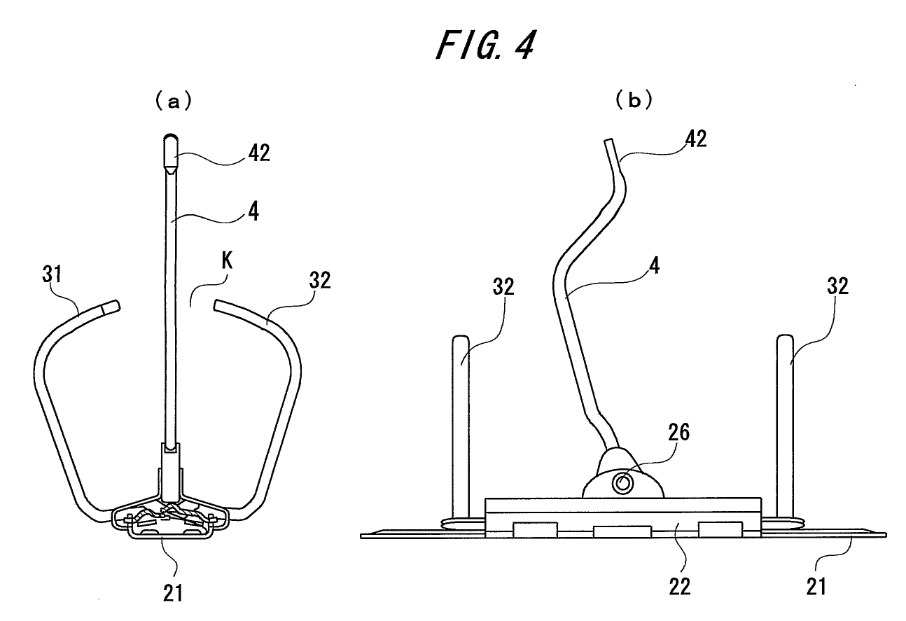

FIG. 5 includes a front view (a) and a side view (b) illustrating an operation of the binder according to the first embodiment of the present invention.

FIG. 6 includes a front view (a) and a side view (b) illustrating a base portion of the binder according to the first embodiment of the present invention.

FIG. 7 includes a cross sectional view (a) taken along line a-a in FIG. 6(a), a cross sectional view (b) taken along line b-b in FIG. 6(a) and a cross sectional view (c) taken along line c-c in FIG. 6(a).

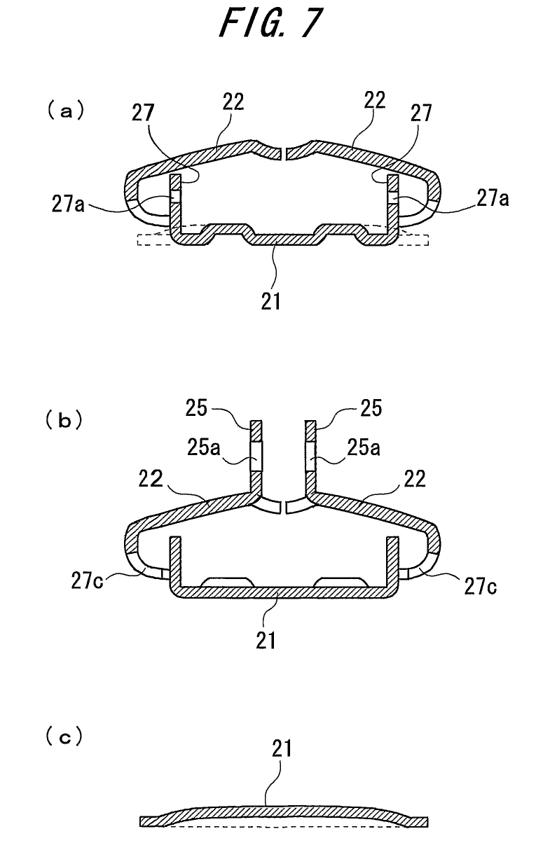

FIG. 8 includes a plan view (a), a side view (b) and a bottom view (c) of a switching lever of the binder according to the first embodiment of the present invention.

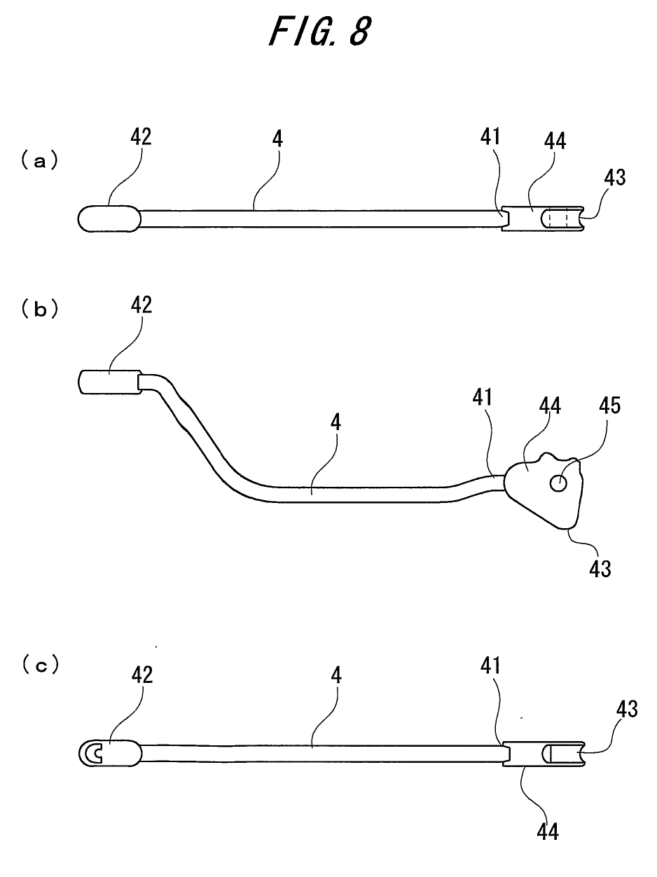

FIG. 9 includes a plan view (a) and a front view (b) of a support member of the binder according to the first embodiment of the present invention.

FIG. 10 includes a plan view (a) and a front view (b) of the base portion of the binder according to the first embodiment of the present invention.

FIG. 11 includes a plan view (a) and a cross sectional view (b) of a plate spring of the binder according to the first embodiment of the present invention.

FIG. 12 includes a plan view (a) and a partial cross sectional view illustrating the process of assembling the binder according to the first embodiment of the present invention.

FIG. 13 includes a plan view (a) and a partial cross sectional view illustrating the process of assembling the binder according to the first embodiment of the present invention.

FIG. 14 includes a plan view (a) and a partial cross sectional view illustrating the process of assembling the binder according to the first embodiment of the present invention.

FIG. 15 includes a plan view (a) and a partial cross sectional view illustrating the process of assembling the binder according to the first embodiment of the present invention.

FIG. 16 includes a plan view (a) and a partial cross sectional view illustrating the process of assembling the binder according to the first embodiment of the present invention.

FIG. 17 includes a plan view (a) and a partial cross sectional view illustrating the process of assembling the binder according to the first embodiment of the present invention.

FIG. 18 is an overall perspective view of a binder according to a second embodiment of the present invention.

FIG. 19 includes a exploded perspective view (a) of the binder according to the second embodiment and a partial side view showing engagement of teeth of a cam portion and an abutment plate thereof.

### BEST MODE FOR CARRYING OUT THE INVENTION

In the following, preferred embodiments of the present invention will be described with reference to the drawings.

### First Embodiment

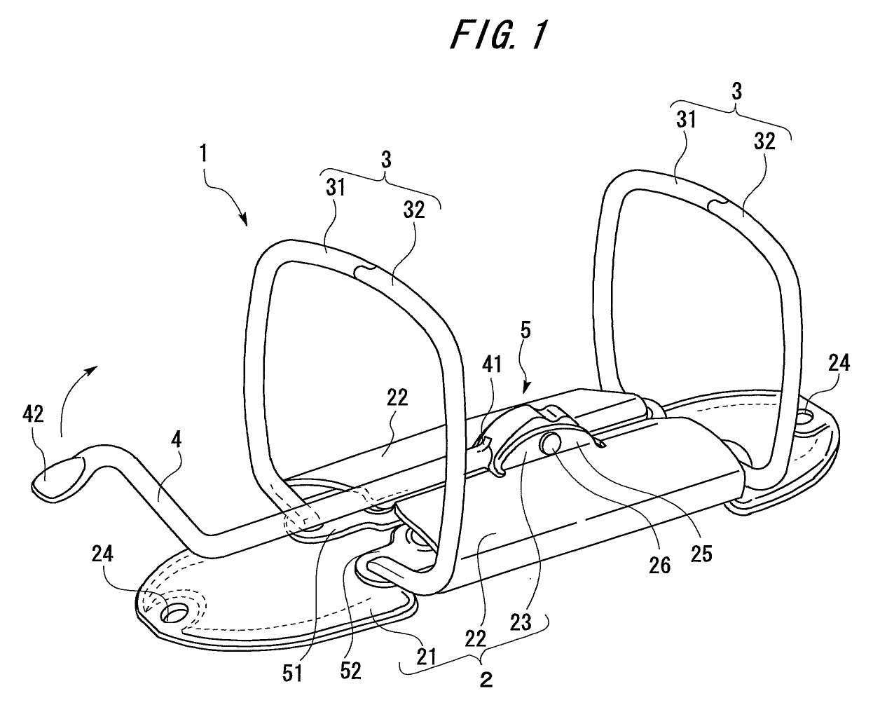

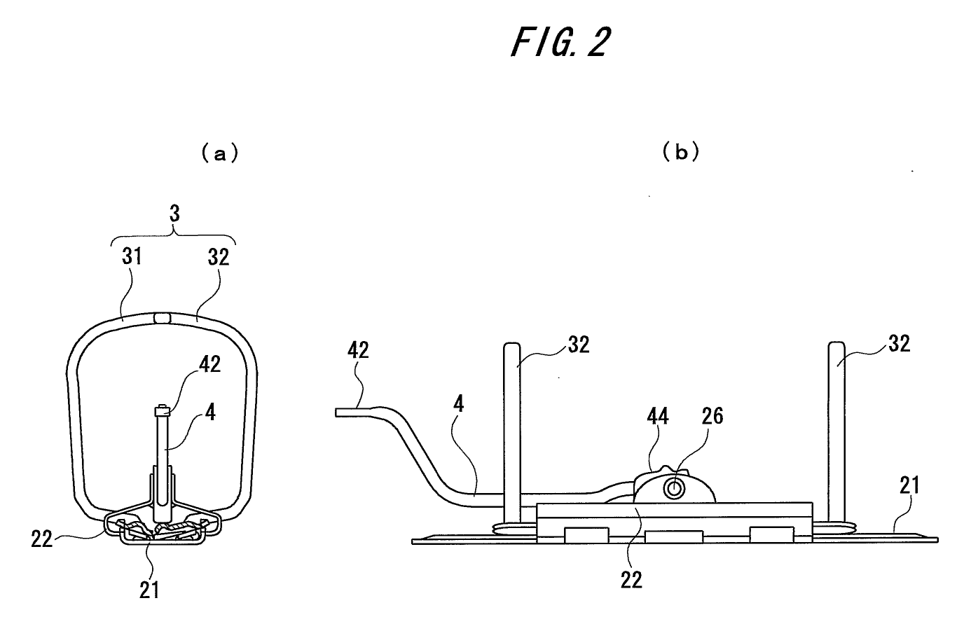

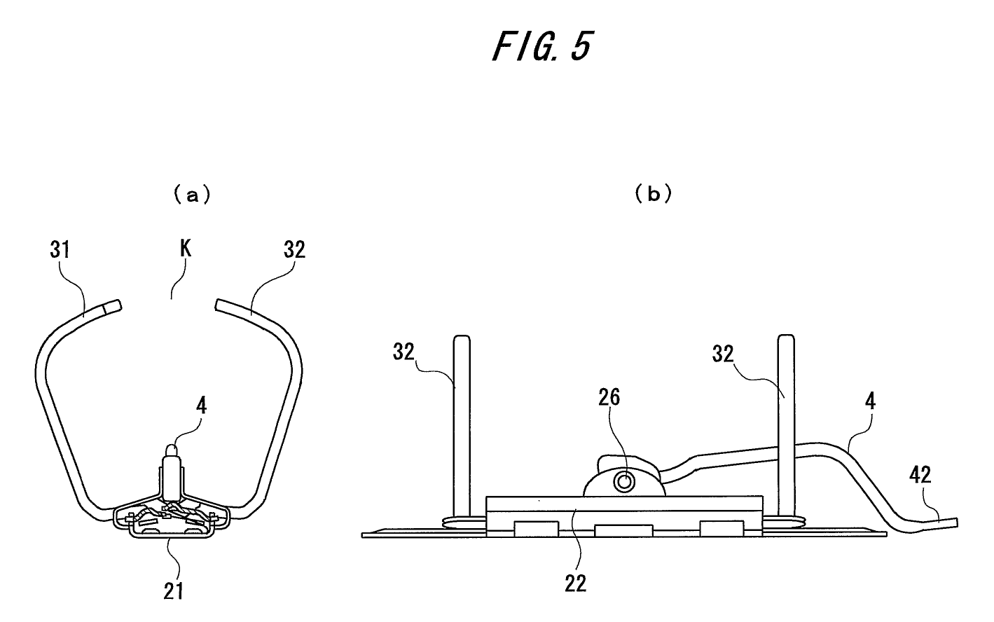

A binder 1 according to this embodiment has a base portion (or base plate) 2, two rings 3, 3 provided on the base portion 2 with a spacing therebetween along the longitudinal direction (length direction) of the base portion 2 and a switching mechanism 5 including a switching lever 4. The two rings 3 can change in their position between a closed ring position shown in FIGS. 1 and 2 for biding sheets of a document or the like and an open ring position shown in FIG. 5 in which a part of the closed ring is opened to allow sheets of document or the like to be filed therein.

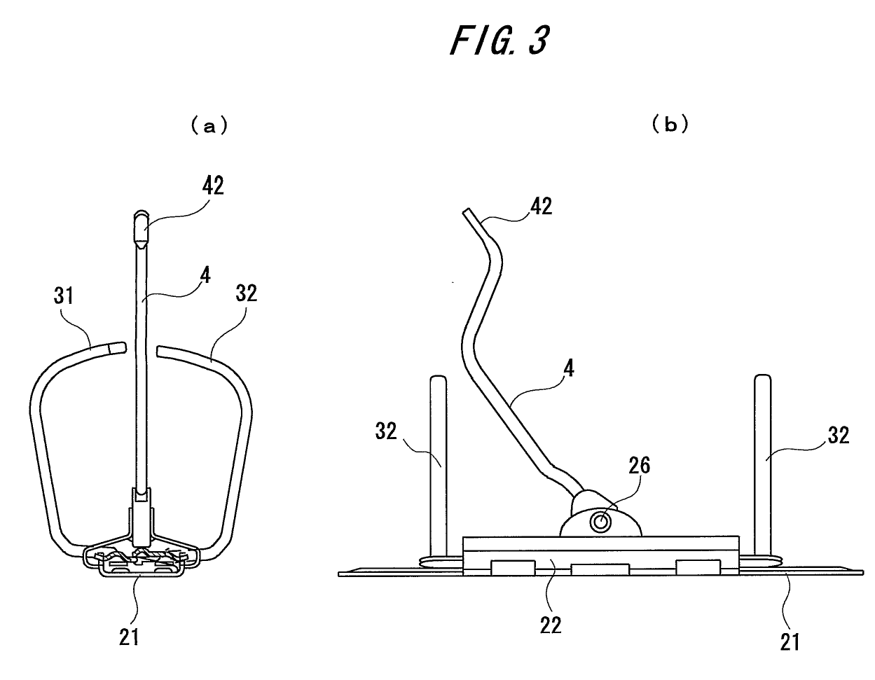

The switching mechanism 5 is provided on the base portion 2 and adapted to switch the position of the rings 3, 3 between the closed ring position and the open ring position. The switching mechanism 5 has the switching lever 4 mounted on the base portion 2 in a swingable (or pivotal) manner. The switching mechanism 5 is designed in such a way that when the rings 3, 3 are in the open ring position, the switching lever 4 can pass through the open portion of the rings 3, 3 as shown in FIG. 3.

Next, details of the above described components will be described with reference to the drawings.

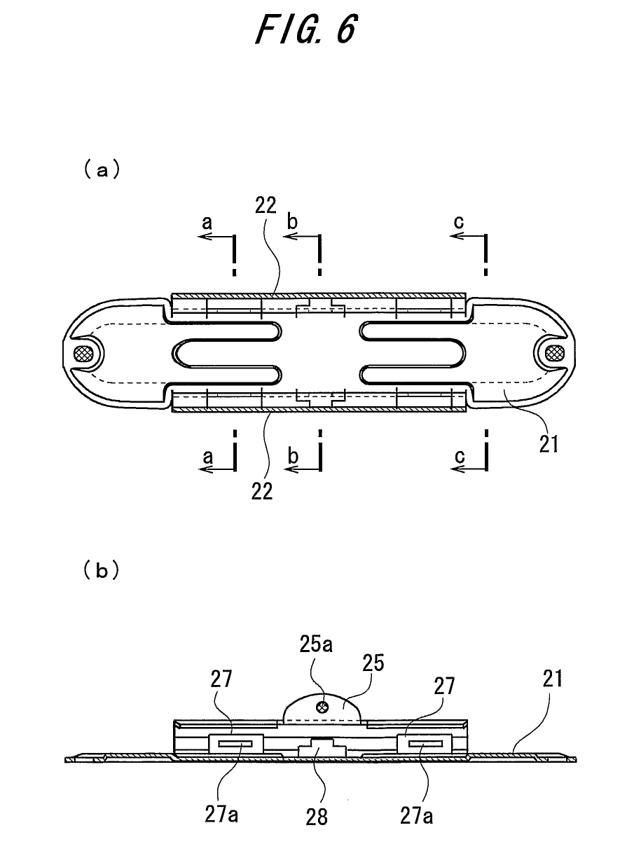

As shown in FIGS. 1 and 6, the base portion 2 has a base body 21 made of a metal plate, cover portions 22 that rise up from the base body 21 to cover the central portion of the base body 21 and a bearing portion 23 provided on the cover portion 22. The base body 21 is formed as a long strip-like plate, on both ends of which is provided respectively a mount hole 24 for mounting it on, for example, the inner side of the cover member of a sheet folder using screws or rivets.

The cover portions 22 rise up from both side edges with respect to the short direction (i.e. the width direction) of the base body 21 and are bent at some position so as to be opposed to each other at the central region with respect to the with direction of the base body 21. The bearing portion 23 is provided at the central region between the two rings 3, 3 and constitutes a part of the hinge for the switching lever 4. Specifically, standing tabs 25, 25 opposed to each other with a gap therebetween are provided on the cover portions 22, and on the central portions of the standing tabs 25, 25 are provided respectively pin holes 25a, 25a (see FIG. 6) through which an hinge pin 26 is to be inserted. The profile of the standing tabs 25, 25 is made low in order to make the height of the switching mechanism 5 low.

Support tabs 27, 27 that support members 51, 52 that will be described later in a swingable (or tiltable) manner rise up from both edges with respect to the width direction of the base body 21. Support tabs 27 are provided at two sites that are spaced apart along the length direction of the base portion 21, or at four positions in all. Each support tab 27 has a slit 27a provided through it in the width direction of the base body 21. Each slit 27a extends along the length direction of the base body 1.

The base body 21, the cover portions 22 and the bearing portion 23 are formed by processing a single metal plate, since in that case, it is possible to make the number of the parts small and make the overall structure simple. In addition, the structure in which the operational portion of the base body 21 is covered with the cover portions 22 is intended to enhance the appearance and safety.

Each ring 3 has a first ring member 31 and a second ring member 32, wherein the ring 3 assumes the closed ring position when their ends 30 are in contact with each other and assumes the open position when their ends 30 are spaced apart from each other. The switching mechanism 5 is constructed in such a way that it can move the ring members 31, 32 in such directions as to bring their ends 30 closer to and away from each other. Thus, a consideration has been made to make it possible to improve operationality in inserting and removing a document or the like by increasing the degree of opening of the ring 3 that is defined as the maximum distance between the ends 30 (i.e. the gap at the open portion K).

The ring members 31, 32 are constructed substantially symmetrically as seen from the front. Accordingly, the open portion K (see FIG. 5) that is formed when the ends of the ring members 31, 32 are spaced apart from each other is situated above the base portion 2 and above the center region, with respect to width direction, of the base portion (base body) 2. Thus, in this structure, it is easy to set the opening/closing timing of the rings 3, 3 in relation to the swing position of the switching lever 4. In other words, in this structure, it is easy to design the relationship between the swing angle of the switching lever 4 and the open/close angle of the rings 3, 3. The reason for this is as follows.

By making both the ring members 31, 32 horizontally symmetrical, it is possible to situate the open portion K of the ring precisely at the central portion, with respect to the width direction, of the base portion 2. On the other hand, the switching lever 4 is also situated at the central portion, with respect to the width direction, of the base portion 2, and swings along the length direction of the base portion 2. Therefore, it is possible to situate the center of the open portion K of the ring precisely on the path of the swinging of the switching lever 4. Thanks to this feature, the switching lever 4 can pass through the open portion K even in the early stage after the ends of the ring members 31, 32 start to move away from each other (i.e. in the stage in which the gap at the open portion K is small). Theoretically speaking, if the gap at the open portion K is a little larger than the diameter of the switching lever 4, the switching lever 4 can pass through it.

The switching lever 4 has a base end portion 41 that is hinged to the base portion 2 and a free end 42 that is to be handled. On the base end portion 41 is provided a cam portion 43 for changing the degree of opening of the rings 3 in accordance with the swing position of the free end 42. In this way, by making the degree of opening of the rings 3 adjustable only by operating the switching lever 4, it is possible to set the relationship between the operation angle of the switching lever 4 and the opening angle of the rings 3 freely. Therefore, it is possible to adapt the arrangement not only to the horizontally symmetrical ring members 31, 32 but also rings having various shapes.

The switching lever 4 itself is made by bending a metal rod, and a cam member 44 is fixedly attached to the base end portion 41 thereof. The cam portion 43 is provided on the cam member 44. The cam member 44 is made of polyacetal resin. On the cam member 44 is provided an shaft hole 45 through which a hinge pin 26 is to be inserted. Thus, the cam member 44 fixedly attached on the base end portion of the switching lever 4 is hinged to the bearing portion 23 by means of the shaft pin 26.

The switching mechanism 5 has two support members (or boost plates) 51, 52 arranged side by side on the base body 21. Each of the support members 51, 52 can be inclined in the lateral direction perpendicular to the length direction of the base body 21. On one support member 51 are fixed and supported the base ends of the first ring members 31, and on the other support member 52 are fixed and supported the base ends of the second ring members 32. The support members 51, 52 are provided in such a way as to extend along the length direction of the base body 21. Accordingly, the first ring members 31, 31 and the second ring members 32, 32 are fixed near both the ends, with respect to the length direction, of the respective support members 51 and 52.

Each support member 51, 52 is constructed as a strip-like plate made of a metal plate and has one side edge portion and the other edge portion. The one side edge portions of the support members 51, 52 are hinged to the base portion 2, and the other edge portions are partly overlapped each other on the base body 21 of the base portion 2.

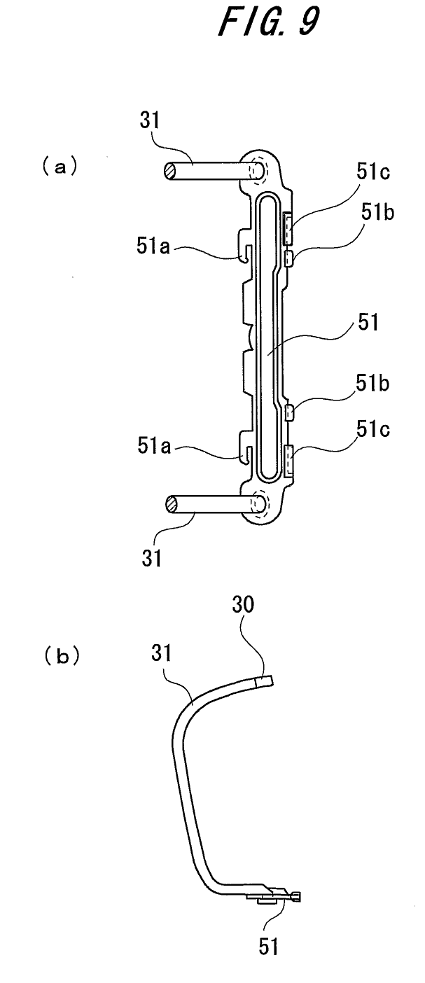

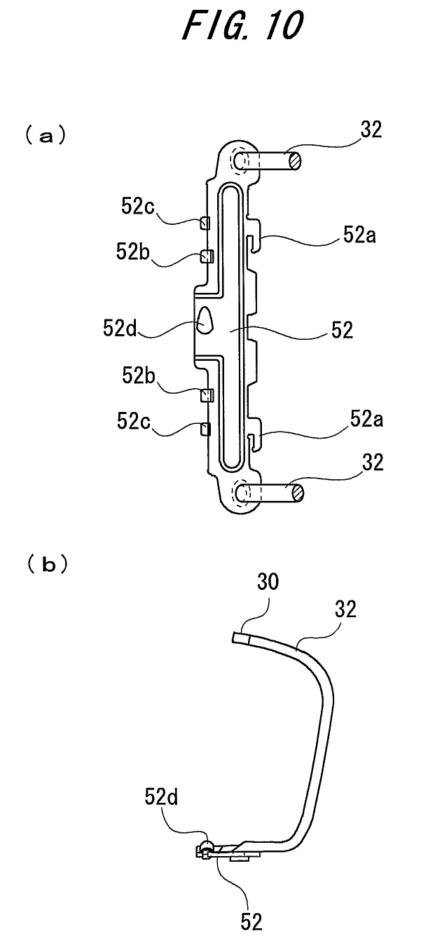

Each support member 51, 52 is produced by machining a single metal plate and substantially symmetrical when seen in a plan view as shown respectively in FIGS. 9 and 10. However, the shapes of them differ a little in the presence of a lap portion that will be described later.

Specifically, hook tabs 51a, 52a to be inserted respectively into the slits 27a, 27a of the support tabs 27, 27 that rise from the base body 21 are provided on the left side edge portion of the support member 51 and the right side edge portion of the support member 52, when the binder 1 is seen from the front. The hook tabs 51a project outwardly (toward the left) in the width direction of the support member 51 and then extend along the length direction of the support member 51 (toward the front). The hook tabs 52a project outwardly (toward the right) in the width direction of the support member 51 and then extend along the length direction of the support member 51 (toward the front). Thus, the support members 51, 52 are supported on the corresponding support tabs 27, 27 in a swingable manner in a provisionally engaging state.

The left support member 51 and the right support member 52 have lap portions that overlap each other. In this embodiment, four projecting tabs 52b, 52c are formed with intervals therebetween on the other side edge portion of the right support member 52. Two projecting tabs 51b and two projecting tab receiving portions 51c are provided with intervals therebetween at positions opposed to the projecting tabs 52b, 52c of the support member 52 respectively on one side edge portion of the left support member 51. The projecting tabs 52b of the support member 52 lie in an overlapping manner on the two projecting tabs 51b of the support member 51 opposed thereto. The projecting tabs 52c of the support member 52 lie in an overlapping manner under the projecting tab receiving portions 51c of the support member 51 opposed thereto.

A plate spring (or an elastic member) 55 that biases the support member 52 toward the direction for moving the ends 30 of the ring members 31, 32 away from each other is provided between the base body 21 and the right support member 52 among the two support members 51, 52. Since it is sufficient to provide the plate spring 55 only for one support member 52, it is possible to make the structure simple. In addition, a consideration has been made to make it possible to operate the two support members 51, 52 simultaneously to change the position of the ring 3 between the closed ring position and the open ring position only by operating the switching lever 4.

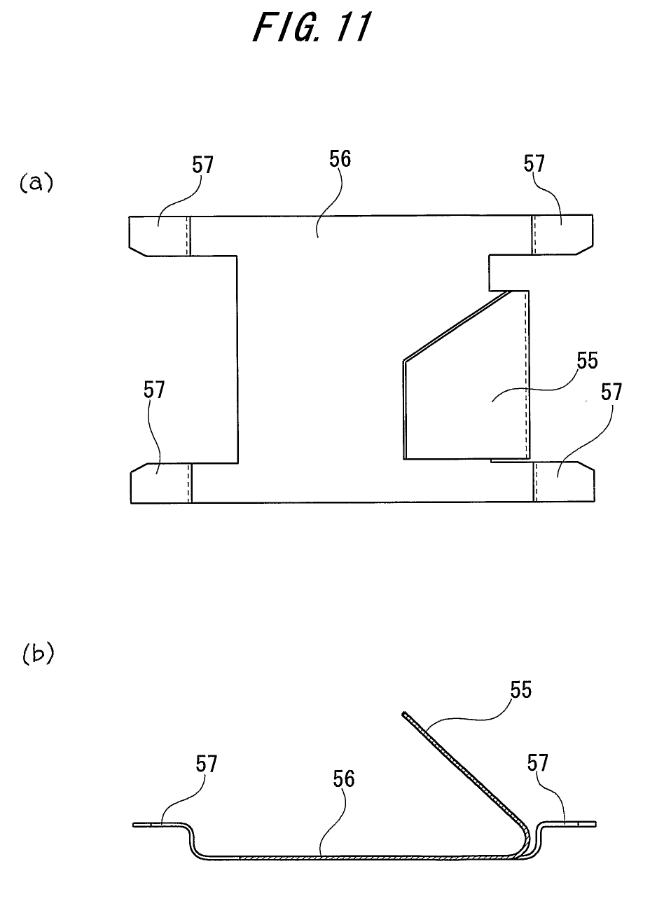

The plate spring 55 has a flat plate portion 56 that is positioned on the base body 21 as shown in FIG. 11. The plate spring 55 rises from the flat plate portion 56 and is bent inwardly. At the four corners of the flat plate portion 56 are provided engaging tabs 57 respectively. The engaging tabs 57 are hooked on the T-shaped slit portions 28 provided on the base portion 2 so as to be positioned.

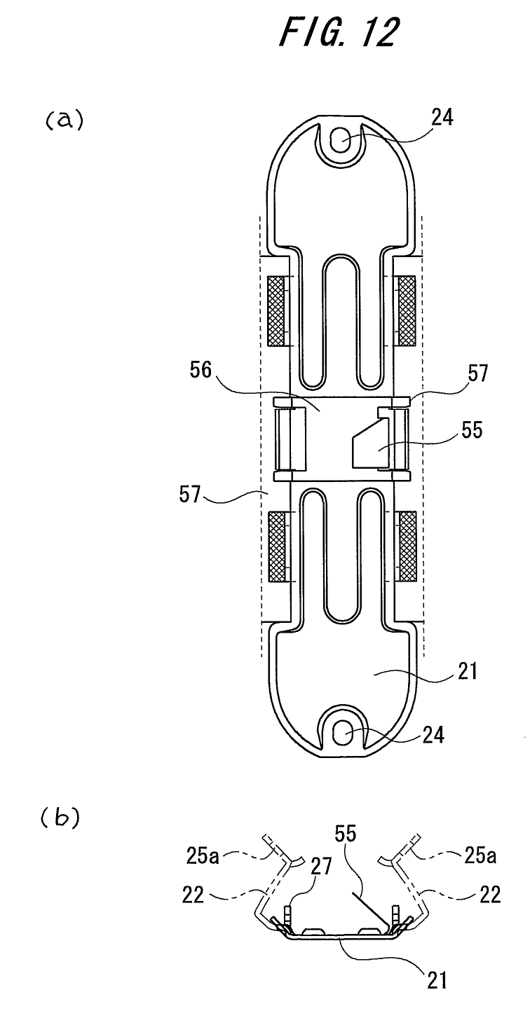

FIGS. 12 to 17 show the process of assembling the switching mechanism 5.

First, the cover portions 22 of the base portion 2 are brought into a half bent state as illustrated in phantom lines in FIG. 12. The plate spring 55 is set on the base body 21 in this state.

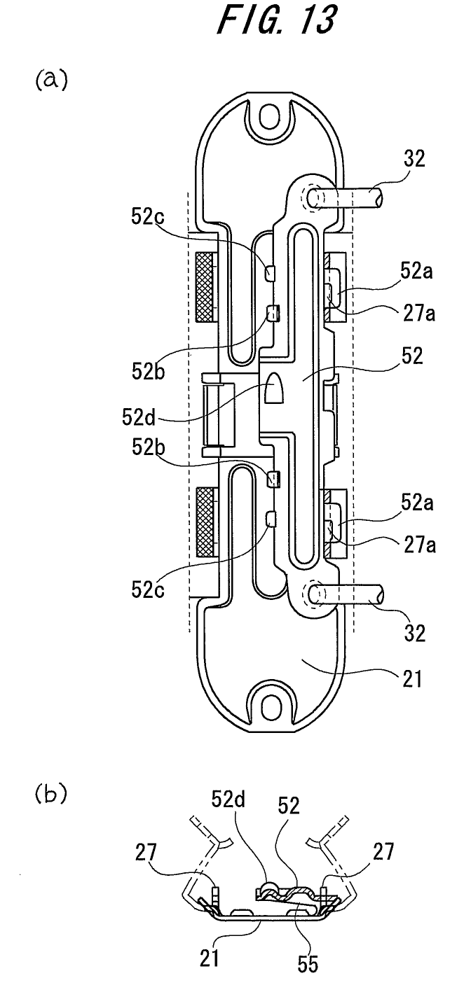

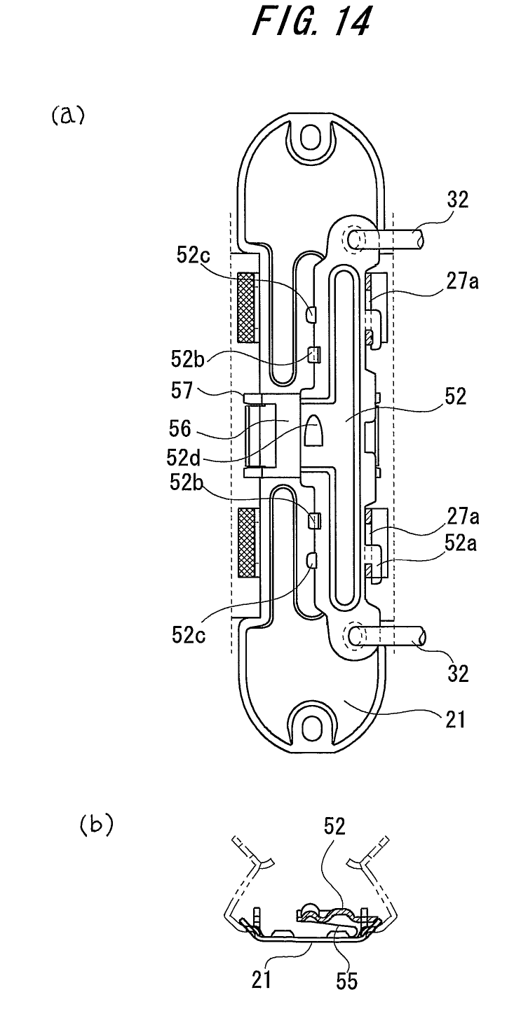

Next, as shown in FIG. 13, the right support member 52 is set on the base portion 2. In this process, the hook tabs 52a, 52a of the support member 52 are inserted into the slits 27a, 27a formed on the rising portions of the cover portion 22, and then the support member 52 is slid toward the front as shown in FIG. 14. Thus, a state in which the hook tabs 52a is hardly disengaged from the slits 27a is realized and a structure having a provisional hinge function is achieved. In this state, the support member 52 is biased from below by the plate spring 55. Therefore, its side edge portion that is opposite to the side edge portion having the hook tabs 52a is swung (or inclined) upwardly with the hook tabs 52 being the pivot.

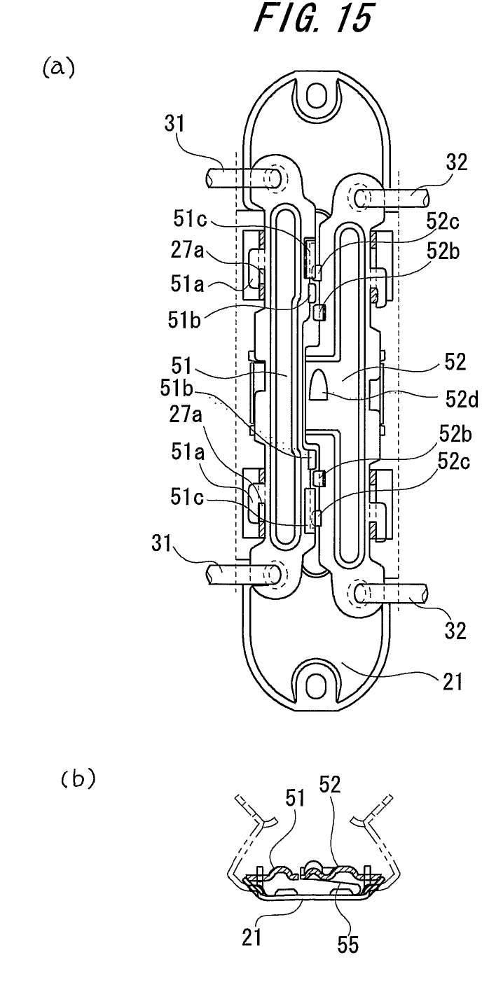

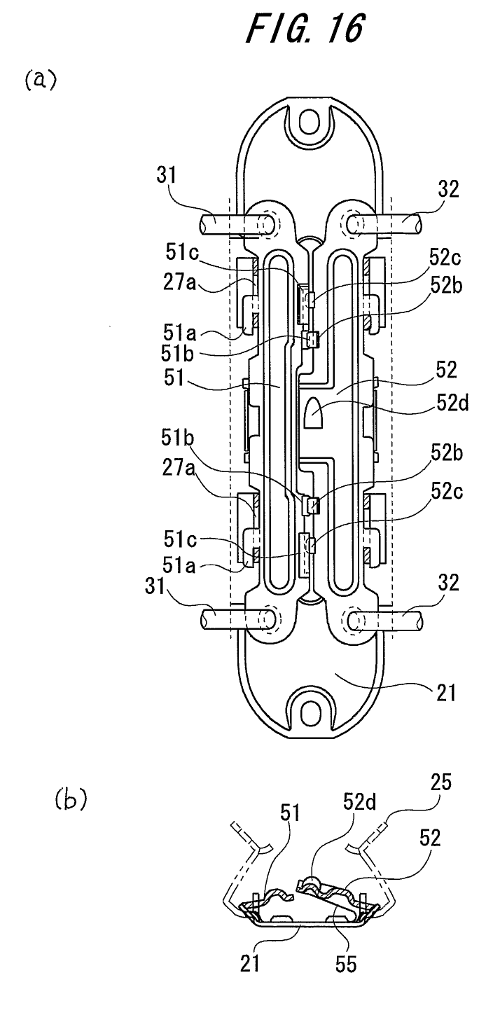

Next, the left support member 51 is set on the base portion 2 as shown in FIGS. 15 and 16 in a manner similar to setting of the right support member 52. In this process, the support member 51 is set in such a way that the two projecting tab receiving portions 51c, 51c thereof on the side edge portion opposite to the side edge portion having the hook tabs 51a are laid, in an overlapping manner, over the projecting tabs 52c, 52c of the previously set supporting member 52 that are opposed thereto. In addition, the support member 51 is set in such a way that the two projecting tabs 51b, 51b thereof are laid, in an overlapping manner, beneath the projecting tabs 52b, 52 of the support member 52 that are opposed thereto. In the state after the above setting process is completed, the side edge portions of two support members 51, 52 are biased upwardly by the plate spring 55 as shown in FIG. 16. By this force, the rings 3, 3 can be kept in the open ring position.

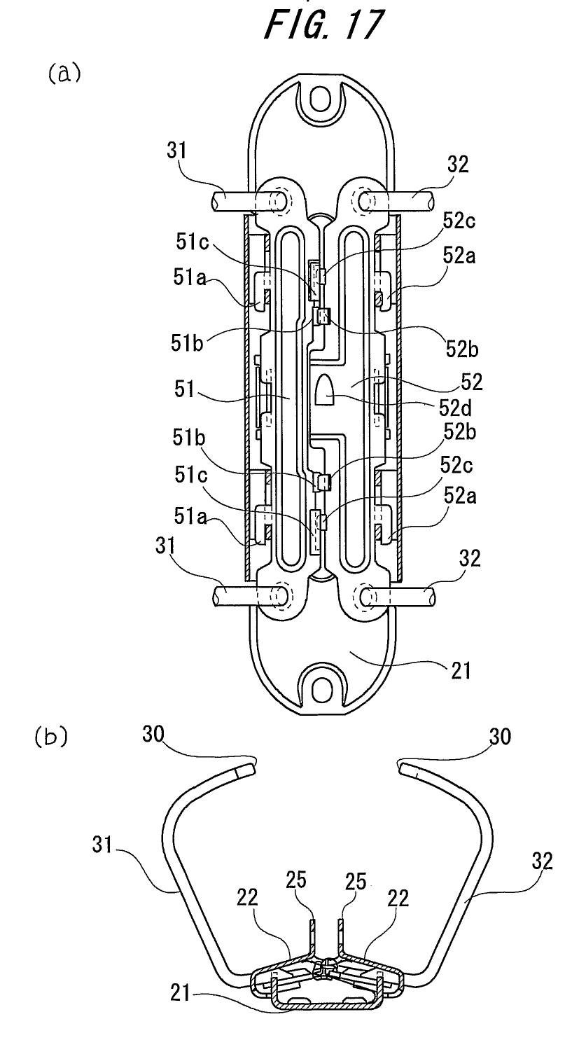

Next, as illustrated in solid lines in FIG. 17, the cover portions 22, 22 on both sides are bent to their predetermined positions. After that, the cam member 44 of the switching lever 4 is positioned between the standing tabs 25, 25, then the hinge pin 26 is inserted, and retaining processing is applied by, for example, swaging. In this way, the switching lever 4 is hinged to the base portion 2.

The supported member 52 is provided with a bulging portion 52d. the bulging portion 52d is situated just below the cam portion 43 of the switching lever 4. When the switching lever 4 is in the binding position swung to one side as shown in FIG. 1, the cam portion 43 thereof is adapted to be in contact with the bulging portion 52d on the upper side and to press it down to retain the rings 3, 3 in the closed ring position.

This structure is configured in such a way that when the switching lever 4 is swung in the direction indicated by an arrow from the binding position of the switching lever 4 shown in FIG. 1, the ring 3 gradually changes to the open ring position to allow passing of the switching lever 4 before the switching lever 4 collides the ring 3.

According to this embodiment, it is possible to operate the two support members 51, 52 simultaneously only by manipulating the switching lever 4 to change the position of the rings 3, 3 into the closed ring position or the open ring position. In addition, the structure is configured in such a way that when the rings 3, 3 are in the open ring position, the switching lever 4 can pass through the open portion K of the rings 3, 3. Accordingly, even in the state in which the ring 3 is in the open ring position, it is possible to cause the free end 42 of the switching lever 4 to pass the ring 3 to the outside thereby keeping the switching lever 4 in a retracted state as shown in FIG. 5. Therefore, while a document or the like is inserted or removed, it is possible to prevent the switching lever 4 from assuming a obstructive position.

Furthermore, each of the rings 3, 3 is composed of the first ring member and the second ring member that have a substantially arcuate shape, and therefore bending of the rings can be performed easily.

### Second Embodiment

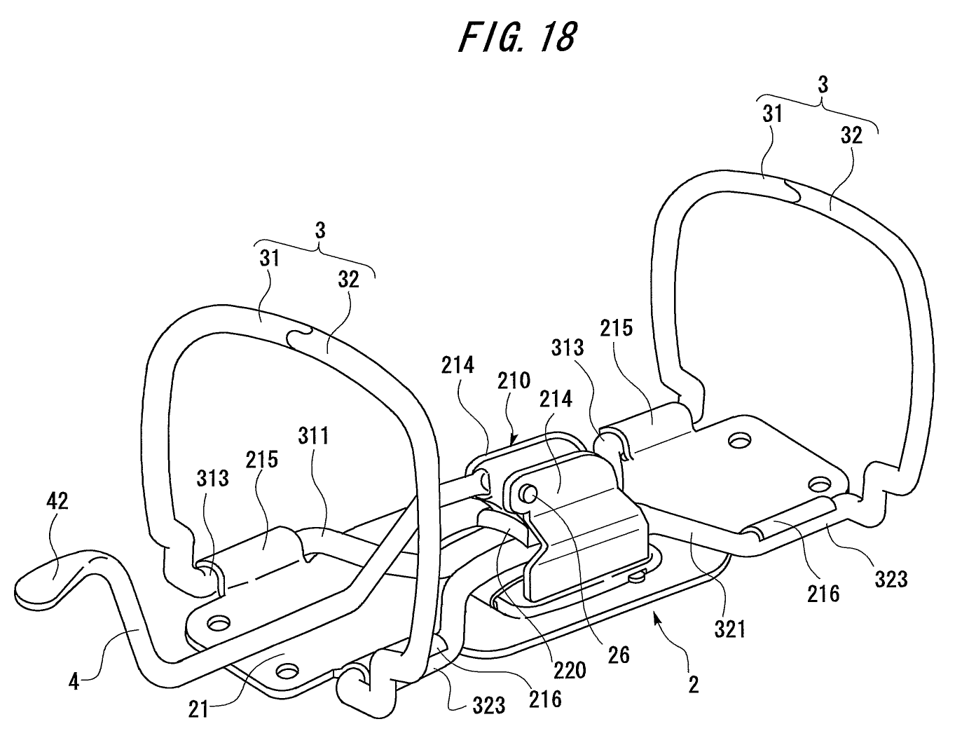

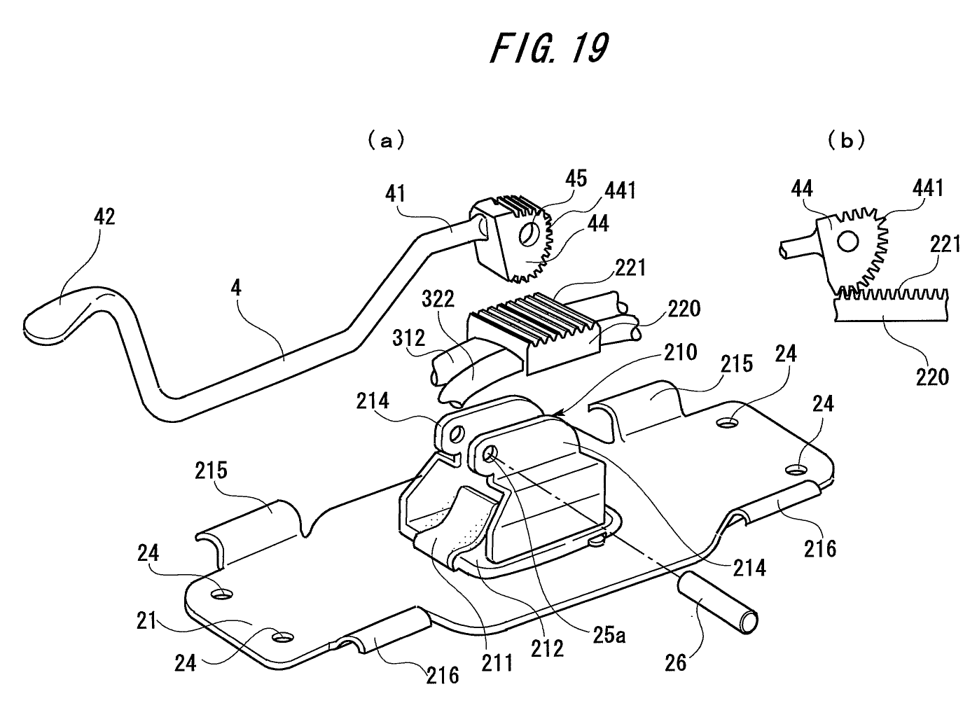

FIGS. 18 and 19 show a second embodiment of the present invention. In the second embodiment, the portions having the same function as those in the first embodiment will be designated by the same reference signs, and descriptions thereof will be omitted.

The binder according to this embodiment also has a base portion (base plate) 2, two rings 3, 3 provided on the base portion 2 with a certain spacing therebetween along the longitudinal direction (length direction) of the base portion 2 and a switching mechanism 5 including a switching lever 4. The two rings 3 can change in their position between a closed ring position for binding sheets of a document or the like and an open ring position in which a part of the closed ring is opened to allow sheets of document or the like to be filed therein.

The switching mechanism 5 is provided on the base portion 2 and adapted to switch the position of the rings 3, 3 between the closed ring position and the open ring position and has the switching lever 4 mounted on the base portion 2 in a swingable (or pivotal) manner. The switching mechanism 5 is configured in such a way that when the rings 3, 3 are in the open ring position, the switching lever 4 can pass through the open portion of the rings 3.

In the second embodiment, the base portion 2 is composed of a base body 21 in the form of a strip-like plate and a bearing member 210 provided on the central portion of the base body 21. The bearing member 210 is fixed on the base body 21 by folding down a retaining tab 211 cut and pulled up from the base body 21 over a bottom plate 212 of the bearing member 210. The retaining tab 211 also serves as an elastic member for biasing a press portions 312, 322, which will be described later, upwardly from beneath. Needless to say, a separate elastic member may be provided. The bearing member 210 has two standing tabs 214, 214 rising up from the bottom plate 212, and pin holes 25a are formed on the standing tabs 214.

Each of a pair of two first ring members 31, 31 and a pair of two second ring members 32, 32 among the ring members that constitute the rings 3, 3 is produced by bending a single metal wire. In other words, in this structure a connecting portion 311 of the two first ring members 31, 31 and a connecting portion 321 of the two second ring members 32, 32 also play the role of the support members in the first embodiment. The connecting portions 311, 321 include press portions 312, 322 that are arranged close to each other and extend parallel to each other in the central region of the base body 21.

An abutment plate 220 is provided on the press portion 312, 322. The abutment plate 220 has a so-called rack having engagement teeth 221 formed on its upper surface. The abutment plate 220 is constructed in such a way as to be movable along the press portions 312, 322. The cam portion 44 fixed to the base end side of the switching lever 4 has a so-called pinion having teeth 441 engaging the teeth 221 of the abutment plate 220, formed on a part of its circumferential surface. The switching lever 4 is hinged to the bearing member 210 by means of a hinge pin 26 in such a way that the teeth 441 of the cam member 44 engage the teeth 221 of the abutment plate 220 as shown in FIG. 19 (b). The teeth 221 of the abutment plate 220 and the teeth 441 of the cam member 44 are adapted to engage each other always by a biasing force of said engagement tab 211 applied through the press portion 312, 322.

The cam surface (the portion having the teeth 441) of the cam portion 44 has such a profile that the abutment plate 220 is pressed down to a maximum extent when the free end of the switching lever 4 is in the closing position as illustrated, the press down amount of the abutment plate 220 is decreased gradually before the switching lever 4 collides the ring 3 to cause the ring 3 to start to open, and the pressing down of the abutment plate 220 can be released at the time when the switching lever 4 passes through the open portion of the ring 3. By this feature, it is possible to press down the press portions 312, 322 through the abutment plate 220 and release the pressing with swinging of the switching lever 4.

The connecting portion 311 of the first ring members 31, 31 has two support portions 313 that are arranged with a spacing therebetween and serve as the pivot of the first ring members. The support portions 313 are rotatably held by bent portions 215 formed on one side, with respect to the width direction, of the base body 21. The connecting portion 321 of the second ring members 32, 32 has two support portions 323 that are arranged with a spacing therebetween and serve as the pivot of the second ring members. The support portions 323 are rotatably held by bent portions 216 formed on the other side, with respect to the width direction, of the base body 21.

In the second embodiment also, the advantageous effects similar to those of the first embodiment are basically achieved. However, this second embodiment is more advantageous in that the size of the base plate can be made smaller, the number of the part can be made smaller, the manufactured cost can be made lower and the rigidity of the ring member is higher than those of the binder according to the first embodiment.

Although in this structure the press portions 312, 322 are pressed by the cam member 44 through the abutment plate 220, the cam portion may press the press portions 312, 322 directly to drive them. When so designed, the number of the parts can be further reduced.

In the embodiments, the overall shape of the ring 3 is designed to be rectangular for the following reason. In the open state, the first and second ring members 31, 32 respectively form a substantially U-shape, and when sheets of a document or the like are set up to the substantially vertical intermediate portion of the U-shape, filing of further sheets becomes difficult, whereby excessive filing of sheets is prevented.

Although the two ring members 31, 32 constituting a ring 3 are symmetrical in the above embodiments, the ring members 31, 32 are not necessarily required to be symmetrical as long as the switching lever 4 can pass through the open portion K of the ring. The invention can also be applied to, for example, a structure in which a ring has a D-shape when seen from the front. However, in that case also, it is preferred that the D-shaped ring be constructed in such a way as to be opened at its central portion in opposite directions.

As will be understood by considering technical idea of the present invention, it is sufficient that the switching lever 4 is allowed to pass through the open portion K of the ring. Therefore, the structure of the ring is not limited to one in which the ring opens at its center in opposite directions to form the open portion K, but the ring may open at a position eccentric to some extent (to either the left or the right) in opposite directions. In the latter case, the switching lever may be angled in accordance with the position of the eccentric open portion K. A structure in which only one of the ring members are opened in one direction may also be adopted. In this case, the mount position of the switching lever 4 may be displaced. This idea is effective in the case where an asymmetrical ring is used.

Although the switching lever 4 is supported at two points at both ends of the pin 26 (by two standing tabs 214, 214), it may be supported at one point (of the pin 26).

### INDUSTRIAL APPLICABILITY

The present invention can be applied to a sheet folder for binding sheets of a document or the like.

1. A binder for a document or the like comprising:
a base portion having a width direction and a longitudinal direction;
a ring provided on said base portion that can change in position between a closed ring position for binding a document or the like and an open ring position in which the closed ring is partly opened to allow filing of a document or the like; and
a switching mechanism provided on said base portion for switching between said closed ring position and said open ring position,
wherein said ring comprises a first ring member having an end and a second ring member having an end, the closed ring position being achieved when said ends are in contact with each other and the open ring position being achieved when said ends are spaced apart from each other, and
said switching mechanism includes a switching lever swingably attached to said base portion, and when the switching lever is swung from a state in which said ring is in the closed ring position, the first ring member and the second ring member move away from each other simultaneously whereby an open portion is formed above a central portion, with respect to the width direction, of the base portion, and the switching lever passes through the open portion to come to a retracted state.

2. A binder for a document or the like according to claim 1, wherein said ring comprises a plurality of rings arranged along the longitudinal direction of said base portion with a spacing therebetween, and said switching mechanism is adapted in such a way that when each of said rings is in the open ring position, the switching lever can pass through an open portion of each ring.

3. (canceled)

4. (canceled)

5. A binder for a document or the like according to claim 1, wherein said switching lever has a base end portion hinged to said base portion and a free end to be operated, said base end portion being provided with a cam portion for adjusting the degree of opening of each of said rings in accordance with the swing position of the free end.

6. A binder for a document or the like according to claim 1, wherein said base portion has a base body made of a metal plate, a cover portion that rises from the base body in such a way as to cover a central portion of the base body and a bearing portion provided on the cover portion, said bearing portion constituting a part of a hinge of said switching lever.

7. A binder for a document or the like according to claim 1, wherein said switching mechanism has two support members arranged side by side on said base portion, each of the support members can be inclined in a sideways direction perpendicular to the longitudinal direction of the base portion, said first ring member is supported on one of the support members, said second ring member is supported on the other of the support members, and between at least one of said support members and the base portion is provided an elastic member that biases the support member in such a direction as to cause the ends of the ring members to move away from each other.

8. A binder for a document or the like according to claim 7, wherein said support members are constructed in the form of strip-like members made of metal plates having respective one side edge portions and opposite side edge portions, one side edge portion of each of the support members is hinged to said base portion, the opposite side edge portions of the support portions partly overlap each other on the base portion, and said elastic member is provided at least between one of the support members and the base portion.

9. A binder for a document or the like according to claim 1, wherein said ring comprises two said rings arranged along the longitudinal direction of said base portion with a spacing therebetween; among first ring members and second ring members constituting the two rings, each of the first ring member pair and the second ring member pair is formed by bending a single metal wire; a connecting portion between the first ring members and a connecting portion between the second ring members respectively have press portions arranged close to and parallel to each other in the central region of the base body and support portions serving as pivots of the first ring members and the second ring members; each support portion is supported in a rotatable manner relative to said base body; and said press portion is pressed by a cam portion of said switching lever.

10. A binder for a document or the like according to claim 9, wherein said base portion has a base body made of a metal plate and a bearing portion provided on a central portion of the base body, said bearing member has a bottom plate and two standing tabs opposed to each other that rise from the bottom plate, a base end portion of said switching lever is hinged to both the standing tabs, and said press portion is disposed between said standing tabs.

11. A binder for a document or the like according to claim 9, wherein an abutment plate that is movable along the press portion is provided between said press portion and said cam portion, and teeth engaging each other are provided on a surface of the abutment plate and a circumferential surface of said cam portion.

12. A binder for a document or the like according to claim 1, wherein when said ring is in the open ring position, said switching lever passes through the open portion of the ring and comes to a position opposite to the position of the switching lever at the time when the ring is in the closed position with respect to the ring in between.

13. A binder for a document or the like according to claim 1, wherein said ring comprises a plurality of rings arranged along the longitudinal direction of said base portion with a spacing therebetween, and said switching lever assumes a closed ring position keeping state for keeping said plurality of rings in the closed ring position at a position outside the rings and assumes, after passing through the open portion of the rings when the rings are in the open ring position, a retracted state in which it is retracted to a position outside the plurality of rings that is opposite to the position of the switching lever in said closed ring keeping state with respect to said plurality of rings in between.

14. A binder for a document or the like comprising:
a base portion having a width direction and a longitudinal direction;
a ring provided on said base portion that can change in position between a closed ring position for binding a document or the like and an open ring position in which the closed ring is partly opened to allow filing of a document or the like; and
a switching mechanism provided on said base portion for switching between said closed ring position and said open ring position,
wherein said ring comprises a first ring member and a second ring member, the closed ring position being achieved when ends of the first and second ring members are in contact with each other and the open ring position being achieved when said ends are spaced apart from each other, and
said switching mechanism including a switching lever swingably attached to said base portion, such that when the switching lever is swung from a state in which said ring is in the closed ring position, said ends of the first and second ring members move away respectively from each other whereby an open portion is formed above a central portion, with respect to the width direction, of said base portion, and the switching lever can pass through the open portion to come to a retracted state.

15. A binder for a document or the like according to claim 14, wherein a timing for spacing apart of said ends of the first and second ring members from each other with respect to swing of the switching lever is a predetermined timing at which the switching lever can pass through the open portion.
